(19) United States
(12) Patent Application Publication
(10) Pub. No.: US 2010/0230255 A1
(43) Pub. Date: Sep. 16, 2010

(54) METHOD AND ARRANGEMENT FOR PRODUCING ADHESIVE-BOUND PRINT ITEMS

(75) Inventor: Konrad Boos, Stettfurt (CH)

Correspondence Address: VENABLE LLP, P.O. BOX 34385, WASHINGTON, DC, 20043-9998, US

(73) Assignee: Mueller Martini Holding AG, Hergiswil (CH)

(21) Appl. No.: 12/723,002

(22) Filed: Mar. 12, 2010

(30) Foreign Application Priority Data
Mar. 13, 2009 (EP) 09405049.9

(51) Int. Cl. B65G 47/46; B65G 47/10

(52) U.S. Cl. 198/890; 198/418.2

(57) ABSTRACT

A method and arrangement for producing print items. The arrangement includes a circulating first conveyor with conveying units uniformly spaced-apart to transport horizontally deposited print products that are gathered into loose book blocks and a second conveyor with conveying units uniformly spaced-apart which circulates with synchronized timing with respect to the first conveyor. The second conveyor is assigned to an adhesive-binding machine. The first and the second conveyors are arranged relative to each other so that they present a joint conveying section in which the book blocks are displaceable in a direction transverse to the conveying direction. The arrangement also includes a displacement device arranged to displace the book blocks in the direction transverse to the conveying direction such that the displacement device moves with synchronized timing relative to the first and second conveying units.

### CROSS-REFERENCE TO RELATED APPLICATION

This application claims the priority of European Patent Application No. 09405049.9, filed on Mar. 13, 2009, the subject matter of which is incorporated herein by reference in its entirety.

### BACKGROUND

The present invention relates to a method and an arrangement for producing adhesive-bound print items composed of a plurality of individual print products. The print products are gathered in a gathering section of a circulating conveyor that includes uniformly spaced-apart conveying units and feeders arranged successively along the gathering section. The feeders deposit the printed sheets or signatures onto support surfaces of the conveying units to form loose book blocks. The book blocks are subsequently supplied to a second conveyor that circulates with synchronized timing to the first conveyor and is assigned to an adhesive-binding machine.

The industrial production of brochures, catalogs, telephone directories, paperback books, or other similar print products may be realized using the adhesive-binding method. Individual printed sheets or signatures are first gathered in the correct sequence inside a gathering machine and are subsequently transferred to an adhesive-binding machine or perfect binder for binding.

Gathering machines, as disclosed in prior art, comprise a conveying system that circulates inside a guide track and consists of several successively arranged conveying units for gathering print products into loose book blocks in a gathering section. While positioned on the conveying units, the back edges of the print products are positioned transverse to the conveying direction and face forward in conveying direction. A conveying unit consists, for example, essentially of an inclined table and an end stop, arranged perpendicular to the table, for accommodating the print products. Sheet feeders arranged along the guide track are used to supply the conveying units with print products.

At the end of the gathering section, the conveying units hold completed, loose book blocks which are respectively arranged against the end stops of the conveying units. The transport clamps of the downstream arranged adhesive-binding machine circulate along a track and are supplied with the book blocks. The transport clamps are spaced-apart farther along the gathering section than the conveying units of the conveyor.

To increase the spacing between the transport clamps, the book blocks are therefore moved to the upright position and accelerated in a conveying section arranged between the gathering section and the adhesive-binding machine. Accordingly, the book blocks are positioned approximately parallel to the conveying direction and are transferrable from this position by lifting the book blocks up into the conveying clamps of the adhesive-binding machine.

As disclosed in European patent document EP 1 886 832 A1, the print products or loose book blocks are gathered while positioned transverse to the conveying direction with the back of the book block inclined counter to the conveying direction. The book blocks are accelerated and pivoted to the upright position while in the additional conveying section to increase the spacing between the book blocks. Therefore, the side edges of the book blocks are positioned approximately parallel to the conveying direction and the loose book blocks can be lifted up and clamped in by the conveying clamps of the adhesive-binding machine.

At least in the additional conveying section, the book blocks inside the conveying units maintain their position as a result of a force applied to the flat sides during the acceleration and the movement to the upright position. Lifting devices are furthermore provided on the conveying units for lifting the book blocks to allow the book blocks to be clamped in by the clamping devices for the adhesive-binding machine.

European patent document EP 1 886 833 A1 discloses loose book blocks being gathered in a first conveying section with the backs of the book blocks positioned transverse to the conveying direction and inclined counter to the conveying direction. The book blocks are accelerated in an additional conveying section and are pivoted to the upright position to increase the spacing between the book blocks. The book blocks are positioned with one side edge approximately parallel to the conveying direction. This allows the book blocks to be fed from this position from below into the conveying clamps of an adhesive-binding machine.

Each of the conveying units previously disclosed must carry out a plurality of operations, as explained. This causes high complexity for the conveying units due to the high functionality and correspondingly high structural component expenditure. Further, the number of conveying units with the associated number of sheet feeders or the number of the print products gathered therein increases proportionally. In addition, nearly as many empty conveying units carry out return movements.

### SUMMARY

The subject matter of the application may create an arrangement which achieves the required functionality with less complexity and which also allows the removal of defective products downstream of a gathering region.

According to one embodiment, there is provided a method for producing adhesive-bound print items composed of a plurality of individual print products, comprising: gathering the print products along a gathering section of a first conveyor circulating in a conveying direction, the first conveyor including first conveying units uniformly spaced apart in a conveying direction, the gathering including depositing, with the aid of feeders arranged successively along the gathering section, the printed sheets or signatures horizontally onto support surfaces of the conveying units to form horizontally positioned loose book blocks; subsequently supplying the loose book blocks to a second conveyor that moves with synchronized timing with respect to the first conveyor and is assigned to an adhesive-binding machine, the supplying including displacing the loose book blocks in a conveying section of the first conveyor that follows the gathering section in a direction transverse to the conveying direction from the first conveying units of the first conveyor to second conveying units of the second conveyor which move in the same direction and at the same speed as the first conveying units of the first conveyor.

According to a further aspect of the invention, there is provided an arrangement for producing print items, which have an adhesive-bound back and are composed of a plurality of individual print products, comprising: a circulating first conveyor including first conveying units uniformly spaced-apart in a conveying direction to transport horizontally deposited print products that are gathered into loose book blocks; a second conveyor including second conveying units uniformly spaced-apart in the conveying direction which circulates with synchronized timing with respect to the first conveyor, the second conveyor being assigned to an adhesive-binding machine; wherein the first and the second conveyors are arranged relative to each other so that they present a joint conveying section in which the book blocks are displaceable in a direction transverse to the conveying direction from the first conveying units to the second conveying units; and a displacement device arranged to displace the book blocks in the direction transverse to the conveying direction from the first conveying units to the second conveying units, the displacement device moving with synchronized timing relative to the first and second conveying units.

### BRIEF DESCRIPTION OF THE DRAWINGS

The subject matter of the application will be more readily understood from the following detailed description when read in conjunction with the accompanying drawings, in which:

FIG. 1 is a perspective representation of an arrangement according to an embodiment of the invention;

FIG. 2 is a representation, in part enlarged, of the conveying or displacement section shown in FIG. 1;

FIG. 3 is a cross-sectional view of the conveying or displacement section for the arrangement shown in FIG. 1;

FIG. 4 is a cross-sectional view of an alternative embodiment of the conveying or displacement section for the arrangement shown in FIG. 1; and

FIG. 5 is a perspective representation of an arrangement according to an embodiment of the invention, including a transfer-out mechanism.

### DETAILED DESCRIPTION

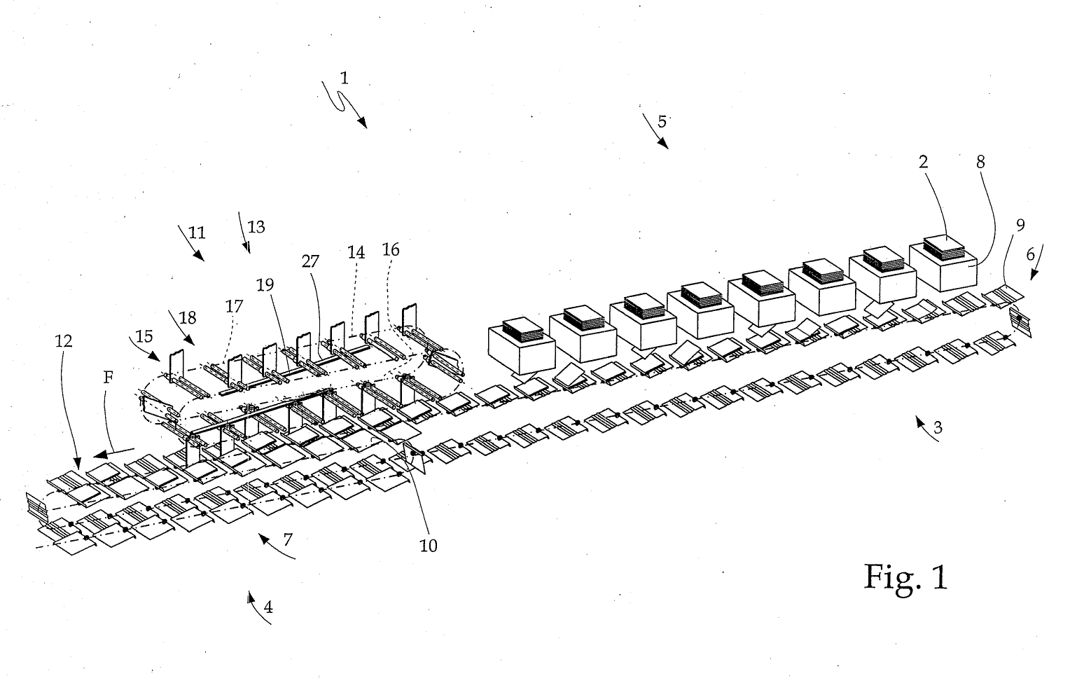

FIG. 1 shows an arrangement 1 for producing print items, composed of several individual print products that include an adhesive-bound back. The arrangement includes a gathering section 5 along which print products 2 are gathered in a manner known per se into loose book blocks 12. The arrangement also includes an adjoining displacement or conveying section 11 on which the book blocks 12 are moved from a first conveyor 3 to a second conveyor 4.

The adhesive-bound print items, composed several individual print products 2, are gathered on the gathering section 5 of a first circulating conveyor 3. The first circulating conveyor 3 includes uniformly spaced-apart first conveying units 6. Feeders 8 are arranged successively along the gathering section 5 and deposit the printed sheets or signatures positioned horizontally onto the support surfaces 9 of the conveying units 6 to form loose book blocks 12.

Subsequently, these book blocks 12 are supplied to a second conveyor 4 arranged adjacent to the first conveyor 3 and circulating with synchronous timing with respect to the first conveyor 3. The second conveyor is assigned to an adhesive-binding machine and comprises uniformly spaced-apart second conveying units 7, as seen in conveying direction F. The first conveyor 3 and the second conveyor 4 are arranged relative to each other to form a joint conveying section or displacement section 11. The conveying section 11 follows the gathering section 5 of the first conveyor 3.

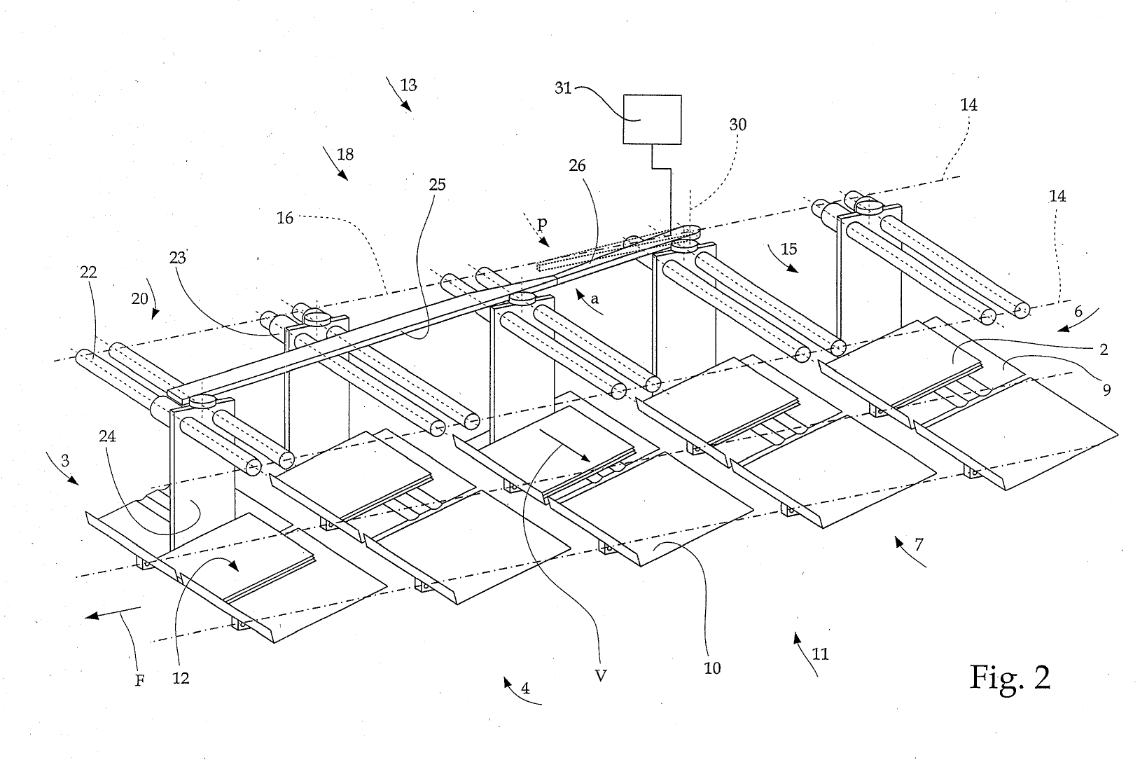

As shown in FIG. 2, the loose book blocks 12 positioned on the conveying section 11 are moved with the aid of a displacement device 13. The displacement device 13 is effective in a direction transverse to the conveying direction F. The displacement device 13 moves with synchronized timing with the first and second conveying units 6, 7 in the direction V transverse to the conveying direction, from the first conveying units 6 to the second conveying units 7. The conveying units 6 and the conveying units 7 move with the same speed and in the same direction in the displacement (conveying) section 11.

The displacement device 13 comprises sliding elements 15 which are arranged on one side of the first conveying units 6 and are movable transverse to the conveying direction F. The sliding elements are connected at uniform distances with at least one guide 20 attached to a circulating traction device 14. The guides 20 include guide rods 22, attached to the traction device 14, with thereon arranged sliding bushings or sleeves 23. The sliding bushings are coupled to the sliding elements 15 to allow displacement.

A control device 18 is assigned to the displacement device 13 along the conveying section 11. The displacement device 13 includes an operating strand 16 that faces the first conveyor 3. The control device 18 is located along the operating strand 16. The control device 18 controls the sliding elements 15. The first conveying units 6 and the second conveying units 7 are arranged parallel to and move with synchronized timing in the conveying section 11. The conveying section 11 is intended for the transfer of the book blocks 12.

The control device 18 comprises a control track 25 that extends above the displacement section in conveying direction F, at an angle of inclination from the first conveyor 3 to the second conveyor 4. The front end of the control track 25 is embodied as a diverter 26 (see FIG. 2). The diverter 26 includes a diverter tongue which pivots about an axis 30 between a first and second end position. The diverter 26 is coupled to an illustrated control 31. With the aid of the diverter 26, the book blocks 12 or parts thereof may be selectively displaced from the first conveying units 6, to the conveying units 7.

In an active control position a of the diverter 26, the sliding elements 15 are deflected as shown with the solid lines in FIG. 2. FIG. 2 displays an inactive control position p, in dashed lines. A second control device 19 moves the sliding elements 15 back to a starting position. The second control device 19 is assigned to a lower slack strand 17 of the displacement device 13. The lower slack strand 17 extends above the operating strand 16. The second control device includes a control track 27 (see FIG. 1) that extends at an angle of inclination above the first conveyor 3.

The sliding elements 15 may be displaced in a displacement direction V. The sliding elements 15 respectively include a surface 24 that may act upon the book blocks 12. The sliding elements 15 may be attached to the traction device 14 in the region of the operating strand 16 to extend downward. In the displacement direction V, the support surfaces 9 of the first conveying units 6 and the support surfaces 10 of the second conveying units 7 are essentially horizontal.

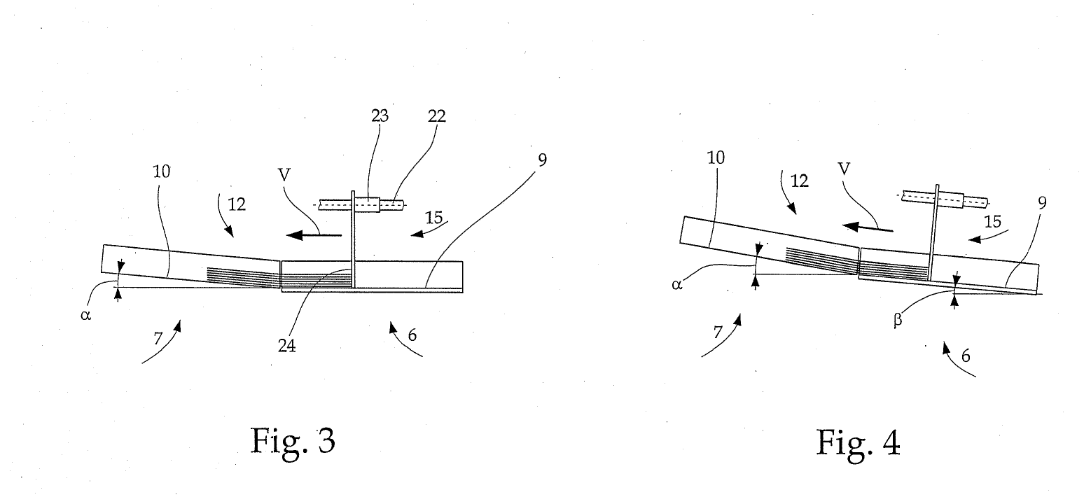

According to another embodiment shown in FIG. 3, the support surfaces 10 extend upward at an angle and without transition in the displacement direction. V. In another embodiment, the support surfaces 9 may be at an upward-directed angle in displacement direction V. In this embodiment, end stops or a holding device may then be provided to hold the book blocks 12 or part thereof in place on the support surfaces 9 prior to reaching the displacement section 11.

The support surfaces 9 may respectively have at most the same angle of inclination as the support surfaces 10. Accordingly, the angle of inclination α of support surfaces 10 may always be greater or equal to the angle of inclination β of support surfaces 9, as shown in FIG. 4. A holding device (not shown) may be provided on the support surfaces 10 to avoid a sliding down of the print products 2 along the support surfaces 10. The holding device may hold the book blocks 12 in place once they reach the conveying units 7.

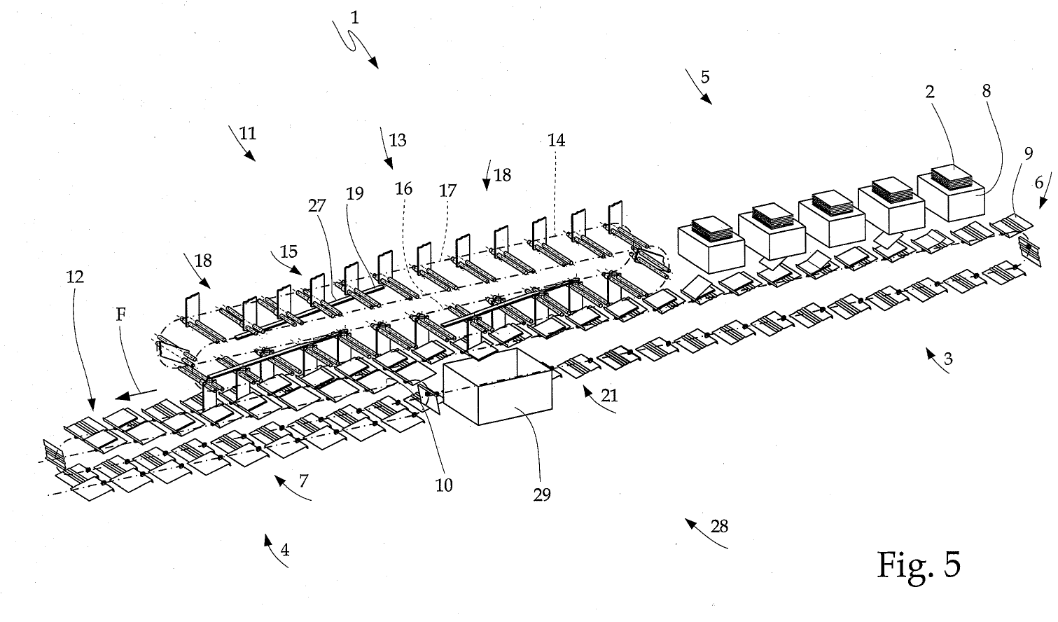

According to another embodiment, a transfer-out section 28 may be provided to selectively remove defective book blocks 12. The transfer-out section 28 may be, for example, provided between the gathering section 5 and the conveying section 11, as shown in FIG. 5. The operating mode of this transfer-out section may be identical to the mode for moving the book blocks 12 from the support surfaces 9 to the support surfaces. A receiving element 29 may be provided in the transfer-out section 28 in place of providing the second conveyor 4. The receiving element 28 may be, for example, a collecting container or a simple transport belt for accommodating the removed book blocks 12. The traction device 14 may also be extended over the conveying section 11 as well as the transfer out section 28 as an alternate to utilizing the conveying section 11. Accordingly, an additional control device 21 may be provided which may resemble the control device 18.

It will be understood that the above description of the present invention is susceptible to various modifications, changes and adaptations, and the same are intended to be comprehended within the meaning and range of equivalents of the appended claims.

What is claimed is:

1. A method for producing adhesive-bound print items composed of a plurality of individual print products, comprising:
gathering the print products along a gathering section of a first conveyor circulating in a conveying direction, the first conveyor including first conveying units uniformly spaced apart in a conveying direction, the gathering including
depositing, with the aid of feeders arranged successively along the gathering section, the printed sheets or signatures horizontally onto support surfaces of the conveying units to form horizontally positioned loose book blocks; and
subsequently supplying the loose book blocks to a second conveyor that moves with synchronized timing with respect to the first conveyor and is assigned to an adhesive-binding machine, the supplying including
displacing the loose book blocks in a conveying section of the first conveyor that follows the gathering section in a direction transverse to the conveying direction from the first conveying units of the first conveyor to second conveying units of the second conveyor which move in the same direction as the first conveying units of the first conveyor.

2. The method according to claim 1, wherein the first conveyor and the second conveyor extend parallel to each other in the conveying section.

3. The method according to claim 1, wherein the displacing includes displacing the book blocks continuously and at an angle of inclination to second support surfaces of the second conveying units.

4. The method according to claim 3, wherein the displacing includes displacing the book blocks along the first support surfaces at most at said angle of inclination.

5. The method according to claim 1, further comprising holding the book blocks or a part of the book blocks in place by friction or force or in a form-locked manner on the first support surfaces prior to the book blocks reaching the conveying section.

6. The method according to claim 1, further comprising holding the book blocks in place by friction or force or in a form-locked manner once the book blocks reach the second support surfaces.

7. The method according to claim 1, further comprising removing defective book blocks in a transfer-out section arranged upstream of the conveying section.

8. The method according to claim 1, further comprising selectively moving the book blocks or parts of the book blocks from the first conveying units to the second conveying units.

9. An arrangement for producing print items, which have an adhesive-bound back and are composed of a plurality of individual print products, comprising:
a circulating first conveyor including first conveying units uniformly spaced-apart in a conveying direction to transport horizontally deposited print products that are gathered into loose book blocks;
a second conveyor including second conveying units uniformly spaced-apart in the conveying direction which circulates with synchronized timing with respect to the first conveyor, the second conveyor being assigned to an adhesive-binding machine, wherein the first and the second conveyors are arranged relative to each other so that they present a joint conveying section in which the book blocks are displaceable in a direction transverse to the conveying direction from the first conveying units to the second conveying units; and
a displacement device arranged to displace the book blocks in the direction transverse to the conveying direction from the first conveying units to the second conveying units, the displacement device moving with synchronized timing relative to the first and second conveying units.

10. The arrangement according to claim 9, wherein the displacement device includes:
at least one circulating traction device;
sliding elements attached uniformly spaced apart to the at least one circulating traction device and displaceable transverse to the conveying direction;
an operating strand facing the conveying section of the first conveyor; and
a control device installed on the operating strand to control and displace the sliding elements.

11. The arrangement according to claim 10, wherein the displacement device includes a slack strand and a second control device assigned to the slack strand to move above the operating strand and to return the sliding elements to a starting position.

12. The arrangement according to claim 9, wherein the displacement device comprises: a guide extending transverse to the conveying direction and coupled to the sliding elements.

13. The arrangement according to claim 10, wherein the displacement devices comprises:
a sliding bushing, and
a guide extending transverse to the conveying direction and coupled to the sliding elements, the guide including a guiding device coupled to the traction device, wherein the sliding bushing is arranged on the guiding device and is coupled to one of the sliding elements.

14. The arrangement according to claim 10, wherein the sliding elements are coupled to the traction device in a region of the operating strand so that the sliding elements extend downward.

15. The arrangement according to claim 14, wherein the sliding elements are displaceable in a displacement direction and include a sliding surface to act upon the book blocks.

16. The arrangement according to claim 10, wherein the control device comprises a control track that extends above the conveying section in the conveying direction at an angle of inclination from the first conveyor to the second conveyor.

17. The arrangement according to claim 16, wherein the control track has a front end comprising a diverter.

18. The arrangement according to claim 11, wherein the second control device includes an angled control track extending above the first conveyor in a direction counter to the displacement direction.
